(19) United States
(12) Patent Application Publication
(10) Pub. No.: US 2010/0255245 A1
(43) Pub. Date: Oct. 7, 2010

(54) BUILDING COMPONENT OF AN ORGANIC OR RECYCLABLE MATERIAL AND METHOD FOR MANUFACTURING SAME

(76) Inventor: Nathan Earle Deveau, Lisbon Falls, ME (US)

Correspondence Address: Kristina M. Grasso;Kristina M. Grasso, Esq. PLLC, P.O. Box 162, Milford, NH, 03055, US

(21) Appl. No.: 12/753,251

(22) Filed: Apr. 2, 2010

Related U.S. Application Data
(60) Provisional application No. 61/166,086, filed on Apr. 2, 2009.

(51) Int. Cl. B32B 27/04; B29C 41/34; B44C 1/28; B32B 21/00; B32B 9/02; C08K 5/1545; C08K 11/00

(52) U.S. Cl. 428/67; 264/129; 264/102; 524/56; 524/13

(57) ABSTRACT

A method of making a wood mosaic building material that involves making a mold, applying a release agent to an interior surface of the mold, adhering a series of wood pieces to the mold with an adhesive, applying a first layer of resin to the wood pieces, curing the first layer of resin, removing the mold, finishing an exposed surface of the wood mosaic building material, and coating the exposed surface with a second layer of resin. The method may also be used to make an organic building material by combining natural ingredients with resin in a mold, allowing the resin to cure, removing the mold, and finishing the organic building material. In one embodiment, the building material is a mixture of wood pieces sealed with an adhesive and coated with a resin. In another embodiment, the building material is an organic material mixed with a resin.

### RELATED APPLICATIONS

This application claims the benefit of U.S. Provisional Patent Application Ser. No. 61/166,086 filed Apr. 2, 2009, which is herein incorporated in its entirety by reference.

### TECHNICAL FIELD

The present invention relates to a building component and a method for manufacturing same. In particular, the building component is an organic and/or recyclable waste material, which is applicable in practically all sectors of the construction and consumer products industries.

### BACKGROUND

It is well established that the Earth's natural resources are slowly, but surely, running out, and that the amount of waste products is getting larger. One way to solve this problem is by recycling. Recycling is the reprocessing of old materials into new products, with the aims of preventing the waste of potentially useful materials, reducing the consumption of fresh raw materials and reducing energy usage. Recyclable materials, or recyclables, may originate from home, business or industry. They include glass, paper, metal, textiles, timber, and plastics. The composting of biodegradable waste, such as food or garden waste, is an analogous form of recycling. Much of the difficulty inherent in recycling comes from the fact that most products are not designed with recycling in mind.

In 1999, recycling and composting activities prevented about 64 million tons of material from ending up in landfills and incinerators. Today, this country recycles 32.5 percent of its waste, a rate that has almost doubled during the past 15 years.

While recycling has grown in general, recycling of specific materials has grown even more drastically: 52 percent of all paper, 31 percent of all plastic soft drink bottles, 45 percent of all aluminum beer and soft drink cans, 63 percent of all steel packaging, and 67 percent of all major appliances are now recycled.

Twenty years ago, only one curbside recycling program existed in the United States, which collected several materials at the curb. By 2006, about 8,660 curbside programs had sprouted up across the nation. As of 2005, about 500 materials recovery facilities had been established to process the collected materials.

### SUMMARY

It is a goal of the present invention to provide a recycling solution by reusing waste materials as a building material for construction and consumer products.

It is another goal of the present invention to provide a method for making a building material out of organic and inorganic waste products.

It is a further goal of the present invention is to provide a building component that is lightweight, durable and strong.

It is an additional goal to provide a building material that is less costly than traditional building material, both in monetary costs and toll on the environment.

Other goals of the present invention include providing a building material that eliminates the need for new natural resources, such as wood, stone, sand and concrete, is environmentally friendly, and allows for the use of residual materials.

In one embodiment, the building material is a mixture of wood pieces sealed with an adhesive and coated with a resin. In another embodiment, the building material is an organic material mixed with a resin.

In one embodiment, a method of making a wood mosaic building material is provided which involves making a mold; applying a release agent to an interior surface of the mold; adhering a plurality of wood pieces to the mold with an adhesive; applying a first layer of resin to the wood pieces; curing the first layer of resin; removing the mold; finishing an exposed surface of the wood mosaic piece; and coating the exposed surface with a second layer of resin.

In another embodiment, a method of making a building material using at least one organic product is provided which involves making a mold; mixing the organic product with a resin; curing the resin; releasing the building material from the mold; finishing the building material; and applying a buffing agent to the building material.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF DRAWINGS

FIG. 1 is a flowchart outlining the method of making the wood mosaic building material of the present invention.

FIG. 2 is a flowchart outlining the method of making the organic material and resin building material of the present invention.

### DETAILED DESCRIPTION

In one embodiment, the resin-binding process of the present invention is used to make boards that can be worked just as intricately as wood. These boards may become exterior and interior building materials, such as walls, floors, doors, beams, trusses, shingles, window frames. In another embodiment, the building material made by this process can also be used to make indoor and outdoor products for the home, such as mosaic countertops, sinks, tubs, kitchenware, houseware, cookware, serving implements, giftware, flatware, cutlery, bathroom accessories, bathroom fixtures, furnishings, home décor, wall décor, lighting fixtures, flooring, cabinets, doors, garden tools; consumer products, such as jewelry, desk accessories, holiday decorations and ornaments, adult and children's toys and games, musical instruments, art supplies, sporting equipment, picnic accessories, fashion accessories, hair and styling accessories, funeral monuments, caskets, urns; building products, such as masonry, shingles; and automotive products, such as car panels, dashboards, steering wheels, bumpers, license plate frames.

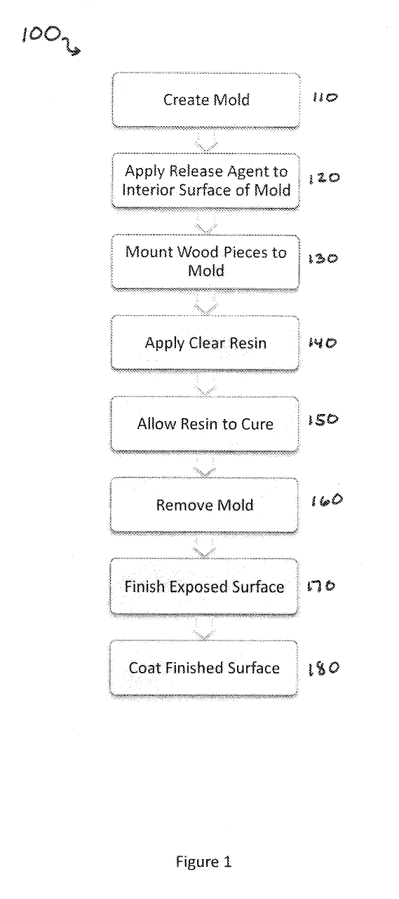

In one embodiment, shown in FIG. 1, the method of the present invention 100 is used to make a wood mosaic building material. A mold is made 110 using one of the following: plaster strips, plaster, fiberglass, plexiglass, rubber, or plywood. If plaster strips are used, the interior surface is waxed, so the form can release easily 120. If other materials are used for the mold, silicone spray, WD-40, or even edible oils may be used as a release agent. Crafters glue is used to hold the wood mosaic pieces to the mold 130. The wood mosaic pieces are made of domestic and/or tropical hardwoods. Common deciduous European and North American hardwoods include oak, beech, ash, maple, and cherry. Examples of European evergreen trees that yield specialty hardwoods include holly, boxwood, and holm oak. Tropical hardwoods include teak, mahogany, ebony, and lauan. Clear resin is then applied by brush or through pouring or spraying 140. After the resin cures 150, the mold is pulled off 160. The newly exposed surface is worked 170 with any number of tools: files, chisels, sandpaper, grinders, dental picks. The smooth, finished surface is then coated with one more layer of resin 180. Alternatively, a clear rubber coating may be used, which may be used to produce children's boots, balls, and more. The resulting building material is a mixture of wood pieces sealed with an adhesive and coated with a resin.

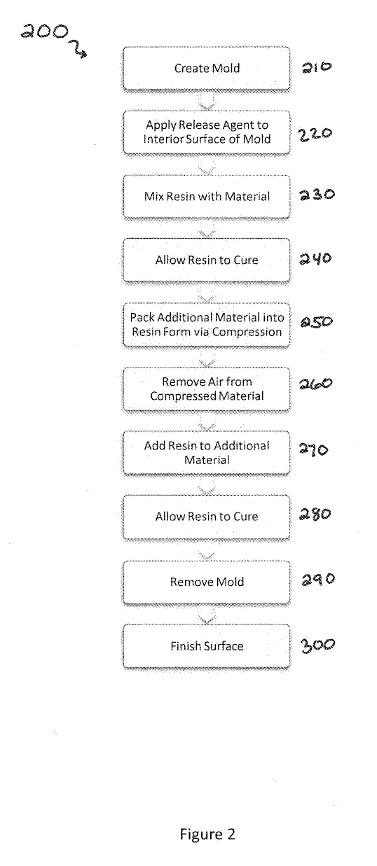

In another embodiment, shown in FIG. 2, the method of the present invention 200 is used to make a resin/natural ingredient building material. As in FIG. 1, a mold is made 210 and a release agent is applied 220. Rubber molds may be supported by plaster, plexiglass, wood, or liquid plastic. Resin is mixed with a organic material 230, such as pine needles, pine cones, leaves, branches, moss, coffee grounds, sawdust, grass, herbs, spices, nut shells, fruit peels, flour, sugar, cocoa, etc. The resin is allowed to cure 240. If, however, the resin is a container, another organic material is packed into the resin form using compressed air or scrap wood 250. In some instances, a vacuum press suction device is used to remove all air from the compressed material 260. Resin is then poured in 270 and allowed to cure 280. The product is then released from the mold 290. If a flat sheet of material is cast, such as a wall board, floor board, or table top, it can be worked with a router, band-saw, planer, or any other woodworking equipment. The final finishing stage 300 may use any of a variety of buffing agents, such as wax, varnish, or polyurethane. The resulting building material is an organic material mixed with a resin.

In an alternative embodiment, a layer of fiberglass is placed between the layers of the natural material to give additional strength to the product. This is particularly useful when creating large items, such as tubs or sinks.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method of making a wood mosaic building material comprising:
making a mold;
applying a release agent to an interior surface of the mold;
adhering a plurality of wood pieces to the mold with an adhesive;
applying a first layer of resin to the wood pieces;
curing the first layer of resin;
removing the mold;
finishing an exposed surface of the wood mosaic piece; and
coating the exposed surface with a second layer of resin.

2. The method of claim 1 wherein the mold is made of material selected from the group consisting of plaster strips, plaster, fiberglass, plexiglass, rubber, plywood, and a combination thereof.

3. The method of claim 1 wherein the release agent is selected from the group consisting of wax, silicone spray, WD-40®, edible oils, and a combination thereof.

4. The method of claim 1 wherein the plurality of wood pieces is a domestic hardwood or a tropical hardwood.

5. The method of claim 1 wherein the plurality of wood pieces is selected from the group consisting of oak, beech, ash, maple, cherry, holly, boxwood, holm oak, teak, mahogany, ebony, lauan, and a combination thereof.

6. The method of claim 1 wherein applying the resin is done by a means selected from the group consisting of brushing, pouring, spraying, and a combination thereof.

7. The method of claim 1 wherein finishing the exposed surface is done using a tool selected from the group consisting of chisels, sandpaper, grinders, dental picks, and a combination thereof.

8. A method of making a building material using at least one organic product comprising:
making a mold;
mixing the organic product with a resin;
curing the resin;
releasing the building material from the mold;
finishing the building material; and
applying a buffing agent to the building material.

9. The method of claim 8 wherein the organic product is selected from the group consisting of pine needles, pine cones, leaves, branches, coffee grounds, fruit peels, sawdust, grass, herbs, spices, flour, sugar, cocoa, and a combination thereof.

10. The method of claim 8 further comprising:
compressing a second material into the building material;
removing any air from the second compressed material;
pouring in an additional amount of the resin;
curing the resin.

11. The method of claim 10 wherein compressing the second material is done by using compressed air.

12. The method of claim 10 wherein removing any air from the second compressed material is done by a vacuum press suction device.

13. The method of claim 8 wherein finishing the building material is done with a tool selected from the group consisting of a router, band-saw, planer, or a combination thereof.

14. The method of claim 8 wherein the buffing agent is selected from a group consisting of wax, varnish, polyurethane, and a combination thereof.

15. The method of claim 8 further comprising placing a layer of fiberglass in between the organic materials before mixing with the resin.

16. A wood mosaic building material comprising:
a plurality of wood pieces;
an adhesive binding the plurality of wood pieces together; and
a resin.

17. The building material of claim 16 wherein the plurality of wood pieces is a domestic hardwood or a tropical hardwood.

18. The building material of claim 16 wherein the plurality of wood pieces is selected from the group consisting of oak, beech, ash, maple, cherry, holly, boxwood, holm oak, teak, mahogany, ebony, lauan, and a combination thereof.

19. A building material comprising:
an organic ingredient; and
a resin.

20. The building material of claim 19 wherein the organic ingredient is selected from the group consisting of pine needles, pine cones, leaves, branches, coffee grounds, fruit peels, sawdust, grass, herbs, spices, flour, sugar, cocoa, and a combination thereof.
